(19) United States
(12) Patent Application Publication
(10) Pub. No.: US 2007/0139551 A1
(43) Pub. Date: Jun. 21, 2007

(54) Video system, apparatus and method to set format of video signal

(75) Inventor: Jin-young Hwang, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co.,Ltd., Suwon-si (KR)

(21) Appl. No.: 11/601,650

(22) Filed: Nov. 20, 2006

(30) Foreign Application Priority Data
Dec. 19, 2005 (KR) 2005-125815

(51) Int. Cl. H04N 7/01; H04N 3/27

(52) U.S. Cl. 348/441; 348/554

(57) ABSTRACT

A video system and a video-signal-format-setting apparatus and method including a video display unit that transmits a predetermined video signal format to a video displaying device, a user input unit that receives from a user an input value for converting the transmitted video signal format, and a format-setting unit that converts the transmitted video signal format according to the input value.

### CROSS-REFERENCE TO RELATED APPLICATION

This application claims the benefit of Korean Patent Application No. 2005-125815 filed on Dec. 19, 2005 in the Korean Intellectual Property Office, the disclosure of which is incorporated herein by reference.

### BACKGROUND OF THE INVENTION

1. Field of the Invention

Aspects of the present invention relate to a video system and a video-signal-format-setting apparatus and method, and more particularly, to a video system and a video-signal-format-setting apparatus and method, which easily converts the format of a video signal transmitted to a video displaying device.

2. Description of the Related Art

Recently, it has become popular to view video via a big screen by connecting a portable device (e.g., a notebook or a PDA) to a video displaying device (e.g., a TV or a monitor).

Video stored in the portable device is viewed easily by connecting the portable device to a device having a large screen, e.g., a TV, via a cable.

The TV should support various formats of video depending on the TV's standard and the area where the TV is used. For example, the TV should support 480i and 720p depending on the TV's resolutions and scanning method, and the NTSC and PAL formats depending on the area where the TV is used.

While the NTSC format is used in the U.S., Canada, and Korea, the PAL format is used in the U.K., China, and Brazil. Thus, a user has to convert the format of a video signal to be transmitted to the user's TV to a format supported by the user's TV since the format differs depending on an area that the TV is used.

If a user views video via a TV using PAL after viewing the video via a TV using NTSC, because NTSC and PAL are different, the video may be abnormally displayed or not displayed at all. Accordingly, a user has to convert the format of the video signal to that supported by the TV.

FIG. 1 is a flowchart of a method of converting a format of a video signal according to a conventional art.

In a method of converting a format of a video signal according to a conventional art as illustrated in FIG. 1, a user connects a portable device and a video displaying device via a predetermined cable S10.

The user must also check the cable connecting the portable device and the video displaying device to determine if the cable supports the signal format S20.

Then, the user opens a user interface to convert a format of the video signal in the portable device S30.

The user sets the format of the video signal to be suitable for the video displaying device via the user interface S40.

The user must manually set various conditions, such as display method, resolution, and scanning method, according to the video displaying device; otherwise, the video displaying device may abnormally display the video or not display the video at all.

In a case where the video display abnormally displays video or does not display the video, the user who did not understand the above manual setting may mistakenly assess a problem with the portable device or the video display. As a result, service costs increase and the perceived product quality decreases.

Korean Unexamined Patent No. 1998-0085457 discloses a method of setting user selection function information in a DVD system, which selects a predetermined item in the user selection function information such as a caption character, a voice, an angle, and/or a parental level, and displays video corresponding to the item set in advance. However, the method is provided to simultaneously set each item of the user selection function information with one processor, and not to reset the set each item of the user selection function information, even when the DVD system is in standby mode, by storing codes corresponding to the each item of the user selection function information in a read only memory (ROM). However, this method does not provide a method of converting a format of a video signal according to a TV if video is displayed via a TV by connecting a portable device and the TV.

### SUMMARY OF THE INVENTION

Aspects of the present invention provide a video-signal-format-setting apparatus and method, which can prevent an abnormal display of video by easily converting the format of a video signal transmitted according to the video display.

According to an aspect of the present invention, there is provided a video system including a device that displays a video signal based on a predetermined format, a video-signal-format-setting apparatus that converts the video signal into a format supported by the device and transmits the converted video signal to the device via a cable connected to the device.

According to another aspect of the present invention, there is provided a video-signal-format-setting apparatus including a video display unit that transmits a predetermined video signal format to a video display, a user input unit that receives, from a user, an input value to convert the transmitted video signal format via video displayed by the device, and a format-setting unit that converts the format of the transmitted video signal according to the input value.

According to still another aspect of the present invention, there is provided a video-signal-format-setting method including transmitting a video signal based on a predetermined format to a video display, receiving, from a user, an input value to convert the transmitted video signal, and converting the transmitted video signal according to the input value.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a method of converting the format of a video signal according to a conventional art;

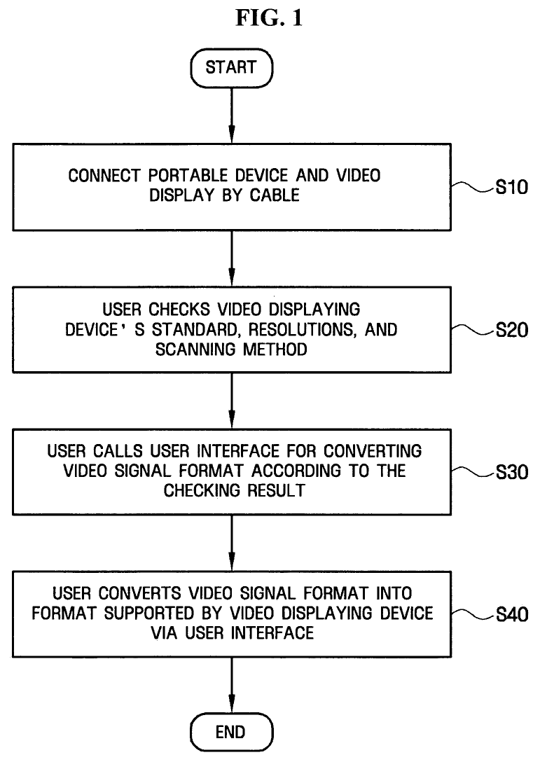

FIG. 2 depicts a video system according to an embodiment of the present invention;

FIG. 3 is a block diagram illustrating an apparatus to set the format of a video signal according to an embodiment of the present invention; and

FIG. 4 is a flowchart of a method of setting the format of a video signal according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims.

Aspects of the present invention are described hereinafter with reference to flowchart illustrations of user interfaces, methods, and computer program products according to embodiments of the invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the operations specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture, including instruction means, that implement the operations specified in the flowchart block or blocks. The computer program instructions may also be loaded into a computer or other programmable data processing apparatus to cause a series of operations to be performed in the computer or other programmable apparatus to produce a computer implemented process such that the instructions that execute in the computer or other programmable apparatus provide for a method to implement the operations specified in the flowchart block or blocks.

Each block of the flowchart illustrations may represent a module, segment, or portion of code, which includes one or more executable instructions to implement the specified logical operation(s). It should also be noted that in some alternative implementations, the operations noted in the blocks may occur out of order. For example, two blocks shown in succession may in fact be executed substantially, concurrently, or the blocks may sometimes be executed in reverse order, depending upon the functionality involved.

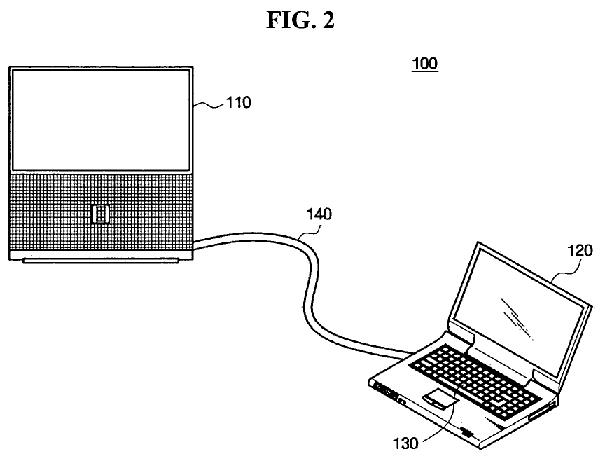

FIG. 2 depicts a video system according to an embodiment of the present invention.

As illustrated in FIG. 2, a video system 100 may include a video displaying device 110 based on a predetermined format of a video signal and a video-signal-format-setting apparatus 120 that transmits a video signal to the video displaying device 110. Here, the video signal displaying device 110 and the video-signal-format-setting apparatus 120 may be connected by a predetermined cable 140. The video-signal-format-setting apparatus 120 may transmit a video signal via the cable 140.

In an embodiment of the present invention, the video signal displaying device 110 refers to a device that displays a video signal, such as, although not limited to, a TV or a monitor, and the video-signal-format-setting apparatus 120 refers to a portable device that transmits a video signal to the video signal displaying device 110, such as, although not limited to, a notebook or a personal digital assistant (PDA), which will be described as an example. Various types of cables, such as S-VHS, component, and DVI cables, can be used to connect the video displaying device 110 and the video-signal-format-setting apparatus 120.

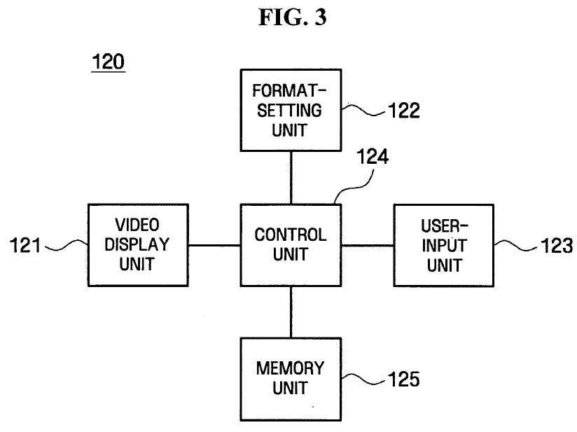

A button 130 (e.g., a hotkey) to convert a video signal transmitted to the video signal displaying device 110 may be provided in the video-signal-format-setting apparatus 120. Accordingly, a user may convert a format of a video signal transmitted to the video displaying device 110 by controlling the button of the video-signal-format-setting apparatus 120. The button may be provided in the video-signal-format-setting apparatus 120, or in an additional device connected to the video-signal-format-setting apparatus 120. The button 130 may be understood with reference to a user input unit 123, described with reference to FIG. 3.

FIG. 3 is a block diagram illustrating an apparatus to set a format of a video signal according to an embodiment of the present invention.

As illustrated in FIG. 3, the video-signal-format-setting apparatus 120 may include a video display unit 121, a format-setting unit 122, a user input unit 123, a control unit 124, and a memory unit 125.

The video display unit 121 may transmit a video signal to the video displaying device 110 (hereinafter, referred to as an external device) via a predetermined cable 140. The video-signal-format-setting apparatus 120 may be a separate device to transmit a video signal stored in or played by a predetermined storage medium, such as a notebook computer or a PDA, or a component of the device to transmit a video signal and to store or play the video signal. Also, the external device 110 may include a TV or a monitor that displays a video signal transmitted by the video-signal-format-setting apparatus 120.

The video display unit 121 may transmit a format of a video signal set by a format-setting unit 122 to the external device 110 via the predetermined cable 140 or through a wireless connection. Also, according to an aspect of the present invention, the video display unit 121 may transmit to the external device 110 a video signal format last set by a user.

The format-setting unit 122 may convert a format of the video signal according to a format supported by the external device 110 and types of a cable connected to the external device 110. Specifically, since the external device 110 supports different formats and cables according to a product standard and an area where the product is used, the format-setting unit 122 converts the transmitted video signal according to the external device 110.

If the external device 110 is a TV, the NTSC, PAL, or SECAM format are used according to an area where the product is used, and 480i, 720p, and 1080i are used according to the resolution and scanning method.

For reference, NTSC, which is used by the U.S., Canada, and Korea, has 525 scan lines and a field frequency of 60 fields/second. PAL, which is used by the U.K., China, Brazil, has 625 scan lines and a field frequency of 50 fields/second. SECAM, which is used by France and Russia, has 625 scan lines and a field frequency of 50 fields/second. The “i” in 480i refers to interlaced scan, and the “p” in 720p refers to progressive scan, and 480 and 720 refer to resolutions. S-VHS and a component cable can be used to connect the external device 110.

The format-setting unit 122 sets the video-signal format to correspond to the external device's 110 standard, resolution, and scan method. However, it is understood that the format-setting unit can further configure the format of the video signal, such as setting a contrast, a caption language, and a brightness, according to an aspect of the present invention.

When the user views, checks the status of, or changes the format of a video signal, the user-input unit 123 receives an input value.

The user input unit 123 may include a convert button 130 that is used when the user wants to convert the format of the video signal. The convert button 130 may be separately provided according to the format of each video signal, or may be provided as a single button. Also, the user input unit 123 may include a select button that enables a user to select a predetermined format.

A case where the convert button 130 to convert a format and a select button to select a format are separately provided is described as a non-limiting example. The convert button 130 and the select button may be integrated. For example, the user may press the convert button 130 when the user wants to convert the format of a video signal, and, unless the user presses the convert button 130 for a predetermined time, the format most recently selected by the user may be selected. Accordingly, the convert button 130 may also perform a function of the select button.

If a user inputs an input value via the user input unit 123, the control unit 124 converts the format of the video signal according to the input value. Here, the control unit 124 may convert the format of the video signal according to a predetermined conversion order. That is, the control unit 124 may control the format-setting unit 122 to convert a format of the video signal according to a conversion order, e.g., NTSC→PAL→480i→720p, stored in the memory unit.125.

Specifically, when the user presses the convert button 130 of the user input unit 123, the control unit 124 controls the format-setting unit 122 to convert a format of the video signal according to the conversion order stored in the memory unit 125. When the user selects a predetermined format via the select button of the user input unit 123, the control unit 124 controls the format-setting unit 122 to convert a format of the video signal based on the selected format.

The memory unit 125 may store a conversion order that controls a conversion of a format of the video signal in the control unit 124. The memory unit 125 may include a cache, read-only memory (ROM), programmable ROM (PROM), erasable PROM (EPROM), electrically erasable PROM (EEPROM), flash memory, static random access memory (SRAM), and dynamic random access memory (DRAM), although not limited thereto.

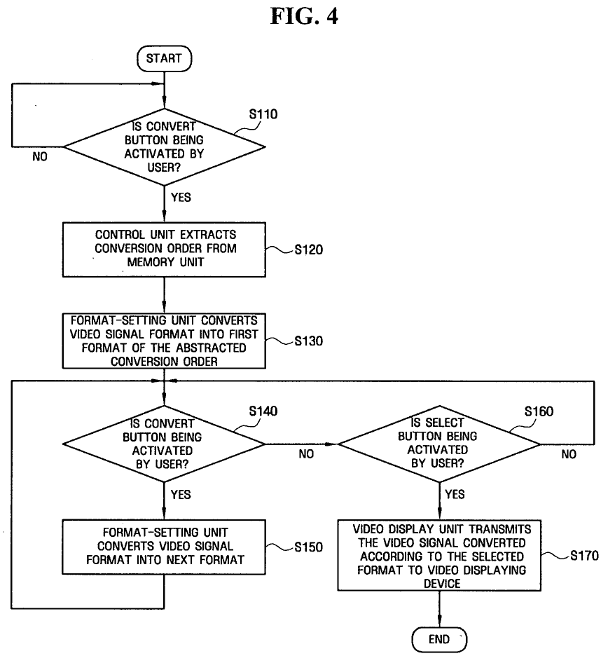

FIG. 4 is a flowchart of a method of setting a format of a video signal according to an embodiment of the present invention.

In the method of setting the format of the video signal, as illustrated in FIG. 4, the control unit 124 determines whether a user inputted an input value to convert a format of a video signal via the user input unit 123 S110. Specifically, the user can determine whether a video is displayed normally by viewing the video signal, which is transmitted from the video display unit 121, via the external device 110.

If the video is not displayed normally, the user may confirm that a format of the video signal is not suitable; as a result, the user may input an input value to convert a format of the video signal via the convert button 130 of the user input unit 123. According to an aspect of the present invention, the convert button 130 and the select button may be provided separately, which will be described as an example, or the convert button 130 and the select button may be integrated.

If the control unit 124 confirms that the user inputted an input value to convert a format of the video signal, the control unit 124 extracts a conversion order of a video format from the memory unit 125 S120. The conversion order stored in the memory unit 125 may be set in advance, set by a user, or set as a default. The conversion order stored in the memory unit 125 may be deleted, changed, or updated if a new format is created or an existing format is not used anymore. The conversion order may, for example, be: NTSC→PAL→480i→720p, as described above.

The control unit 124 controls the format-setting unit 122 according to the abstracted conversion order, and the format-setting unit 122 converts a format of the video signal based on a first format of the abstracted conversion order S130. Specifically, if the user manipulates the convert button 130, the control unit 124 enables a format of the video signal to be converted by the format-setting unit 122 according to the abstracted conversion order at a predetermined time interval, or enables the format of the video signal to be successively converted by the format-setting unit 122 depending on the number of times a user presses the convert button 130, according to the abstracted conversion order.

For example, if the abstracted conversion order is NTSC→PAL→480i→720p, the control unit 124 may enable a format of a video signal to be converted into NTSC when a user presses the convert button 130 once, and enable a format of a video signal to be converted into PAL when a user presses the convert button 130 twice.

After enabling the video signal to be converted into a first format of the abstracted conversion order, the control unit 124 determines whether the user pressed the convert button 130 again S140.

If the user presses the convert button 130 again, the control unit 124 enables the video signal to be converted according to a next format of the abstracted conversion order S150.

In S140, if the control unit 124 confirms that the user presses the select button S160, the control unit 124 enables the format-setting unit 122 to convert the video signal into a format of the corresponding order because the control unit confirms that the user selected the format of corresponding order.

The video display unit 121 transmits the video signal, which is converted based on a format corresponding to a case where a user manipulates the select button, to the external device 110 so that the user can view video S170.

Accordingly, a user can easily convert a format of a video signal by manipulating buttons, which enables conversion of a video signal even when video is abnormally displayed in the external device 110 due to the external device's 110 different standard and resolutions; as a result, normal video can be displayed.

According to aspects of the present invention, the video system 100, the video-signal-format-setting apparatus 120 and method therefore can convert a format of a video signal transmitted to a video displaying device 110 to prevent video from being abnormally displayed in the video displaying device 110 because the format of the video signal transmitted to the video displaying device 110 is not compatible with the video displaying device 110; as a result, normal video can be displayed.

The term “unit”, as used herein, may be, but is not limited to, a software or hardware component, such as a Field Programmable Gate Array (FPGA) or an Application Specific Integrated Circuit(ASIC), which performs certain tasks. A module may advantageously be configured to reside in the addressable storage medium and configured to execute in one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A video system comprising:
a device to display a video signal having a predetermined format; and
a video-signal-format-setting apparatus, comprising a convert button on a surface thereof, to convert the video signal to the predetermined format supported by the device based on a selection of the predetermined format from a plurality of formats according to a number of times that the convert button is pressed by a user, and to transmit the converted video signal to the device through a wired or wireless connection with the device.

2. The system as claimed in claim 1, wherein the video-signal-format-setting apparatus comprises:
a video display unit to transmit the video signal to the device;
a user input unit comprising the convert button to receive from the user an input value corresponding to the number of times that the convert button is pressed by the user; and
a format-setting unit to convert the video signal to the predetermined format according to the input value.

3. The system as claimed in claim 2, wherein the user input unit further comprises:
a select button to enable the video signal to be converted to the predetermined format,
wherein the predetermined format is selected from the plurality of formats according to the number of times that the convert button is pressed, and the format-setting unit converts the video signal to the predetermined format when the select button is pressed by the user.

4. The system as claimed in claim 2, wherein the predetermined format is selected from the plurality of formats according to the number of times that the convert button is pressed, and the format-setting unit converts the video signal to the predetermined format when the convert button is not pressed for a predetermined period of time.

5. The system as claimed in claim 2, further comprising:
a memory unit to store a conversion order of the plurality of formats, so that each format of the plurality of formats corresponds to a unique and possible input value; and
a control unit to control the format-setting unit to convert the video signal to the predetermined format according to the stored conversion order and the input value.

6. The system as claimed in claim 5, wherein the user-input unit further comprises:
a select button to enable the video signal to be converted to the predetermined format,
wherein the control unit selects the predetermined format from the plurality of formats according to the input value, such that the input value corresponds to the predetermined format in the conversion order; and the control unit controls the format-setting unit to convert the video signal to the predetermined format when the select button is pressed by the user.

7. The system as claimed in claim 5, wherein the control unit selects the predetermined format from the plurality of formats according to the input value, such that the input value corresponds to the predetermined format in the conversion order; and the control unit controls the format-setting unit to convert the video signal to the predetermined format when the convert button is not pressed for a predetermined period of time.

8. The system as claimed in claim 1, further comprising a portable device to store the video signal or read a storage medium storing the video signal.

9. The system as claimed in claim 8, wherein the video-signal-format-setting apparatus is provided as a component of the portable device.

10. The system as claimed in claim 1, wherein the video-signal-format-setting apparatus is a notebook computer, a desktop computer, or a personal digital assistant (PDA).

11. The system as claimed in claim 1, wherein the device is a TV and the predetermined format is one of NTSC, PAL, and SECAM and/or one of 480i, 720p, and 1080i.

12. A video-signal-format-setting apparatus comprising:
a video display unit to transmit a video signal to a video displaying device;
a user input unit comprising a convert button on a surface of the video-signal-format-setting apparatus to receive from a user an input value corresponding to a number of times that the convert button is pressed by the user, wherein a predetermined format supported by the video displaying device is selected from a plurality of formats according to the input value; and
a format-setting unit to convert the video signal to the predetermined format according to the input value

13. The apparatus as claimed in claim 12, wherein the user input unit further comprises:
a select button to enable the video signal to be converted to the predetermined format,
wherein the predetermined format is selected form the plurality of formats according to the number of times that the convert button is pressed, and the format-setting unit converts the video signal to the predetermined format when the select button is pressed by the user.

14. The apparatus as claimed in claim 12, wherein the predetermined format is selected from the plurality of formats according to the number of times that the convert button is pressed, and the format-setting unit converts the video signal to the predetermined format when the convert button is not pressed for a predetermined period of time.

15. The apparatus as claimed in claim 12, further comprising:
a memory unit to store a conversion order of the plurality of formats, so that each format of the plurality of formats corresponds to a unique and possible input value; and
a control unit to control the format-setting unit to convert the video signal to the predetermined format according to the stored conversion order and the input value.

16. The apparatus as claimed in claim 15, wherein the user-input unit further comprises:
a select button to enable the video signal to be converted to the predetermined format,
wherein the control unit selects the predetermined format from the plurality of formats according to the input value, such that the input value corresponds to the predetermined format in the conversion order; and the control unit controls the format-setting unit to convert the video signal to the predetermined format when the user presses the select button.

17. The apparatus as claimed in claim 15, wherein the control unit selects the predetermined format from the plurality of formats according to the input value, such that the input value corresponds to the predetermined format in the conversion order; and the control unit controls the format-setting unit to convert the video signal to the predetermined format when the convert button is not pressed for a predetermined period of time.

18. The apparatus as claimed in claim 12, wherein the apparatus receives the video signal from a portable device.

19. The apparatus as claimed in claim 12, wherein the apparatus is a notebook computer, a desktop computer, or a personal digital assistant (PDA).

20. The apparatus as claimed in claim 12, wherein the video displaying device is a TV and the predetermined format is one of NTSC, PAL, and SECAM and/or one of 480i, 720p, and 1080i.

21. A video-signal-format-setting method comprising:
receiving from a user an input value corresponding to a number of times that a convert button is pressed by the user, wherein a predetermined format supported by a video displaying device is selected from a plurality of formats according to the input value;
converting a video signal to the predetermined format according to the input value; and
transmitting the video signal to the video displaying device.

22. The method as claimed in claim 21, wherein the converting of the video signal comprises:
enabling the video signal to be converted to the predetermined format when a select button is pressed by the user.

23. The method as claimed in claim 21, wherein the converting of the video signal comprises:
enabling the video signal to be converted to the predetermined format when the convert button is not pressed for a predetermined period of time.

24. The method as claimed in claim 21, further comprising:
storing a conversion order of the plurality of formats wherein each format of the plurality of formats corresponds to a unique and possible input value.

25. The method as claimed in claim 24, wherein the converting of the video signal comprises:
selecting the predetermined format from the plurality of formats according to the input value, such that the input value corresponds to the predetermined format in the conversion order; and
enabling the video signal to be converted to the predetermined format when a select button is pressed by the user.

26. The method as claimed in claim 24, wherein the converting of the video signal comprises:
selecting the predetermined format from the plurality of formats according to the input value, such that the input value corresponds to the predetermined format in the conversion order; and
enabling the video signal to be converted to the predetermined format when the convert button is not pressed for a predetermined period of time.

27. The method as claimed in claim 21, further comprising:
receiving the video signal from a portable device before converting the video signal.

28. The method as claimed in claim 21, wherein the video displaying device is a TV and the predetermined format is one of NTSC, PAL, and SECAM and/or one of 480i, 720p, and 1080i.

29. A computer readable recording medium encoded with the method of claim 21 implemented by a computer.
